(19) United States
(12) Patent Application Publication
(10) Pub. No.: US 2003/0075005 A1
(43) Pub. Date: Apr. 24, 2003

(54) Crash-safe pedals in a vehicle

(76) Inventors: Lothar Schiel, Hofheim (DE); Stefan A. Drumm, Saulheim (DE)

Correspondence Address: RATNERPRESTIA, P O BOX 980, VALLEY FORGE, PA, 19482-0980, US

(21) Appl. No.: 10/240,894

(22) PCT Filed: Apr. 2, 2001
(86) PCT No.: PCT/EP01/03723

(30) Foreign Application Priority Data
Apr. 4, 2000 (DE) 100 16 598.2
Oct. 31, 2000 (DE) 100 53 996.3

(51) Int. Cl. G05G 1/14

(52) U.S. Cl. 74/560

(57) ABSTRACT

The present invention relates to a pedal assembly for automotive vehicles. The aim of the invention is to prevent the pedal lever (4) from hitting the leg (13) of the driver when a crash occurs, due to displacement of the actuating rod (11) of the brake booster (9). This object is achieved by preventing the pedal lever (4) from rotating in opposition to the direction of actuation. Several measures are proposed to this end. One of said measures consists in exclusively allowing forces to the transmitted in one direction of actuation, which may be effected with the aid of a tie rod (14) that is unable to transmit any pressure forces. Another suggestion aims at mounting the pedal lever on a separately arranged transverse bar (21) rather than on the splashboard (5) as before.

### BACKGROUND OF THE INVENTION

The present invention relates to a crash-safe pedal assembly in a vehicle for the actuation of an actuating rod, in particular for a control unit for use in a brake system. The vehicle operator exerts a force on an actuating rod by means of a pedal lever, said actuating rod actuating e.g. a control unit that comprises a master cylinder and a brake booster. This will trigger the desired braking operation. As can be seen in FIG. 1, a pedal lever is tilted by the foot force of the driver to actuate the actuating rod, with the longitudinal movement of the actuating rod then initiating the desired processes in the control unit.

In this arrangement, the pedal lever represents a force/travel transmission, meaning that a long pedal travel produces a small travel of the actuating rod. It has been found that this prior art system may become very dangerous to the driver when a crash happens. This is because as the control unit attached to the splashboard displaces a distance towards the splashboard due to an accident, the actuating rod in the passenger compartment will also shift in the direction of the driver. This relatively insignificant movement will be transformed into a large tilting movement of the pedal lever caused by the lever transmission at the pedal lever so that the brake pedal will impact against the foot or the leg of the driver and may injure the driver.

### BRIEF SUMMARY OF THE INVENTION

The present invention, therefore, is based on a crash-safe pedal assembly in a vehicle for the actuation of an actuating rod, in particular for a control unit comprising a master cylinder and/or a brake booster in a brake system. An object of the present invention is related to modifying a prior art pedal assembly of this type so that an injury of the driver is prevented which may be caused in an accident by the pedal lever, especially the free end of the pedal lever of the vehicle. The free end of the pedal lever on which the foot of the driver is placed will be denoted as pedal support in many occasions in the following.

The above object is achieved in that a lever system is so arranged between the pedal lever of the pedal assembly and the actuating rod that the force exerted by the pedal lever on the actuating rod is transmitted by way of a tie rod. Hence, the present invention principally resides in designing the transmission of forces between the pedal lever and the actuating rod so that it is possible to apply the required forces in the direction of actuation, yet the reverse force transmission from the control unit to the pedal lever is largely obstructed. Thus, it is the essence of the present invention that force can be exerted from the driver in the direction of the actuating rod, but no force from the actuating rod to the pedal of the driver. In the inactive position, the pull lever (tie rod) with its end close to the booster bears against the splashboard or any part of the vehicle that is in a force-transmitting connection with the splashboard.

A particularly simple solution for implementing the principle described can be seen in that during the transmission of forces the tie rod is moved substantially perpendicular to the splashboard of the vehicle, and that in the inactive position of the pedal assembly, the end of the tie rod close to the splashboard is in direct proximity to the splashboard or any part that is in a force-transmitting connection with the splashboard as a preferred aspect of the present invention. In this context, the tie rod is arranged in such a manner that, starting from its normal position, it is mainly allowed to move in one single direction only, thereby preventing forces generated in an accident from being transmitted in a rearward direction towards the driver.

In this case, the tie rod will impact against the splashboard or any other part that is rigidly connected to the splashboard in a direct or indirect manner.

Using the features that at least one of the ends of the tie rod , preferably the end of the tie rod that engages the pedal lever, includes a connecting member for force transmission in such a way that only tensile forces are allowed to be transmitted by way of the tie rod, while the connection is disengaged when a force exceeding a threshold value is transmitted provides another possibility of transmitting forces only in one direction. To this effect, provision is made for a force transmission member on at least one of the two ends of the tie rod, the said member being generally allowed to transmit force only in one direction, while the force transmission is interrupted when a force acts in the opposite direction. Transmitting a pressure force from the booster by way of the tie rod in the direction of the driver (brake pedal) is possible only up to a value that was previously defined by construction. Above this value, the force-transmitting connection will be removed to prevent the entire pedal suspension from displacing towards the driver. The features that the connecting member generally has the configuration of a hook show a force transmission member of this type with a particularly simple design. The hook used in this design is aligned in such a manner that it is only able to pull but not push. This way the pulling forces exerted by the driver during actuation are transmitted, but not any pressure forces caused due to an accident.

The features that the pedal lever is designed as a turning lever, with the pivot bearing being supported by a transverse bar that is preferably mounted between the A-columns of the vehicle describe another possibility of enhancing the safety of a driver. Herein the mounting support for the pedal lever is no longer suspended at the splashboard but at a spatially remote transverse bar. This causes forces produced in an accident to be no longer transmitted directly to the pedal lever but only by way of the tie rod which can be appropriately secured, as has already been described hereinabove. The transverse bar may be guided between the A-columns of the vehicle in parallel to the instrument panel or integrally combined with the instrument panel , as the case may be.

It is also easily possible with a like construction to adjust the normal position of the pedal assembly to the height of a driver, as becomes apparent from the features that the turning lever is mounted in a swing support which is rotatable about the transverse bar and that the normal position of the pedal lever is adjustable by turning the swing support. In this process, the fulcrum of the pedal lever is swung about the transverse bar so that the pedal support at the end of the pedal lever is swung upwards to a small driver. A catch-type connection in that the swing support is turned by means of an electric motor, and that the swing support includes a safety mechanism which locks the swing support in its new angular position, is used to fix the newly adjusted position of the swing support. It is preferred that the movement of the swing support is effected by an electric motor with a self-locking worm gear.

Another safety measure is described in the combination of features in that the control units are so mounted on the splashboard that part of the forces caused by a crash are directed at the splashboard against the end of the tie rod facing the splashboard. As the forces exerted on the tie rod in the driver's direction will swing the pedal support in the direction of the splashboard, pressure forces of this type will consequently help to enhance safety. If, however, pressure forces become excessive, the safety mechanism fitted to the force transmission member will remove the connection at a defined force as has already been described with respect to a hook hereinabove.

As the pedal support can be moved downwards in the direction of the splashboard by tilting of the swing support, this possibility may also be used to increase the driver's safety by automatically triggering this movement of the swing support by means of a sensor when an accident occurs.

### BRIEF DESCRIPTION OF THE DRAWINGS

Embodiments of the present invention will be explained in the following by way of the accompanying drawings. In the drawings,

FIG. 1 shows the currently used pedal assembly as known.

FIG. 2 shows a first embodiment of this invention.

FIG. 3 shows a second embodiment of this invention.

FIG. 4 shows the possibility of adjusting the normal position of the pedal lever to the height of the driver in the embodiment of FIG. 3.

FIG. 5 shows the effect of the present invention in an accident when implementing the embodiment of FIG. 3.

### DETAILED DESCRIPTION OF PREFERRED EMBODIMENTS

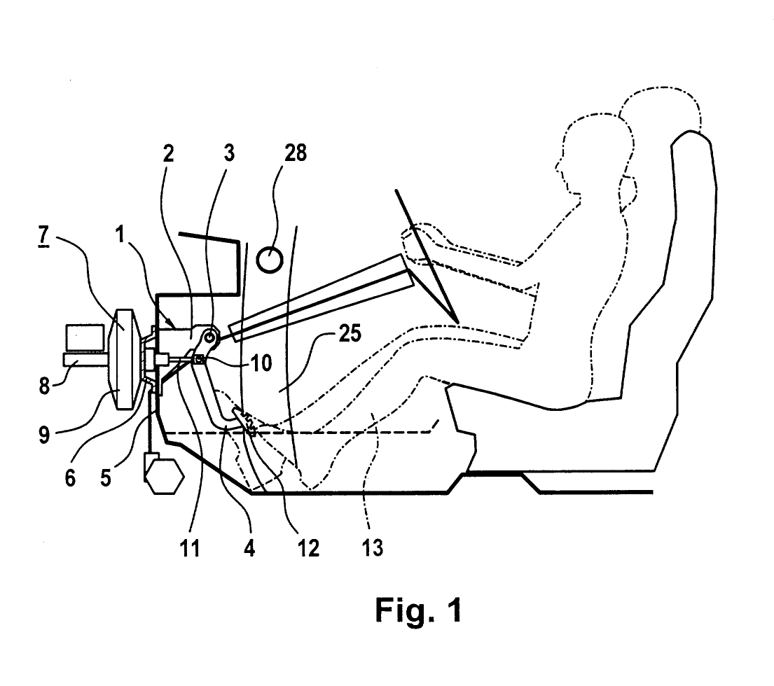

FIG. 1 is a sectional sketch of a passenger compartment. A pedal assembly 1 includes a pedal stand 2 in which a pedal lever 4 is pivotally mounted by way of a first swivel joint 3. The pedal stand 2 is fitted to the splashboard 5 of the vehicle. Opposite the pedal stand 2 a control system 7 is mounted on the splashboard 5 by way of a bracket 6, said control system being comprised of a master cylinder 8 and a brake booster 9. An actuating rod 11 is articulated to the pedal lever 4 by way of a second swivel joint 10 so that in the event of a swinging movement of the pedal support 12 about the swivel joint 3 to the left in FIG. 1 the actuating rod 11 is also shifted to the left. This triggers the known processes in the control system 7 for decelerating the vehicle.

A disadvantage of the prior art system according to FIG. 1 as described hereinabove is that the control system 7 of FIG. 1 allows being shifted to the right when an accident occurs. As the control system 7 is mechanically coupled to the actuating rod 11, the actuating rod 11 will likewise be displaced to the right in FIG. 1, thereby causing an abrupt movement of the pedal 12 in the direction of the foot or leg 13 of the driver on account of the transmission of displacement.

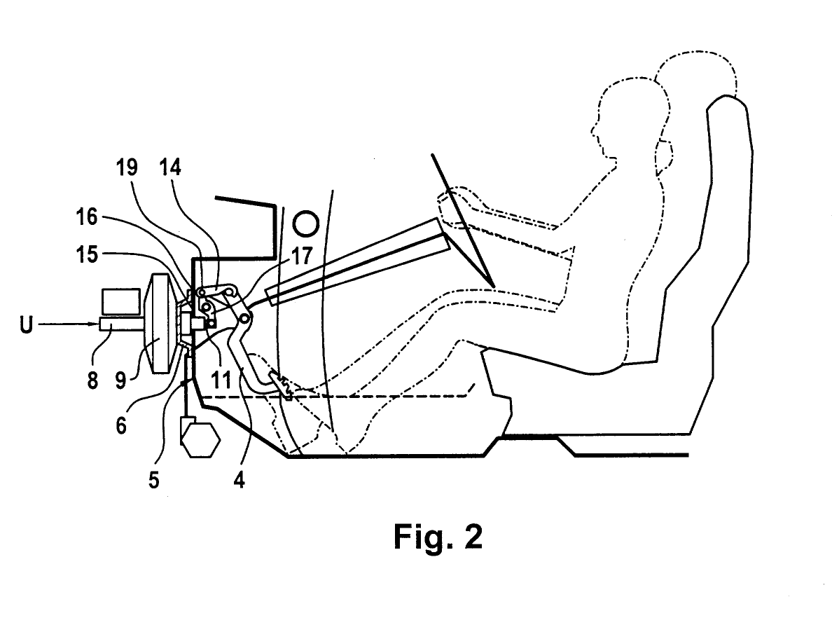

FIG. 2 illustrates a first embodiment of the present invention. In this arrangement, the individual subassemblies are explained only inasfar as there are modifications compared to FIG. 1. As becomes apparent from FIG. 2, the pedal lever 4 no longer acts directly on the actuating rod 11 but only indirectly on a shortened actuating rod 11 (which is not illustrated in detail in FIG. 2) by way of a push rod 14 and a turning lever 17. With a force U now acting on the master cylinder 8 on account of an accident, the brake booster 9 will displace the splashboard 5 and the actuating rod 11 to the right in the area 15. Usually this would also cause a counterclockwise rotary movement of the pedal lever 4 and, thus, jeopardize the driver. However, since the end portion 19 of the tie rod 14 is in very close proximity to the splashboard 5 or, respectively, has its end position at the splashboard/booster fastening member 6, the tie rod is not or only slightly able to move to the left so that the pedal 12 maintains its position. As can be seen in FIG. 2, part of the force U is transmitted also to the zone 16 at the splashboard 5 by way of the bracket 6, said force counteracting the force exerted by the end portion 19. It is thereby achieved that the force exerted by the accident, by way of the tie rod 14, will move the pedal 4 about the hinge 3 away from the driver.

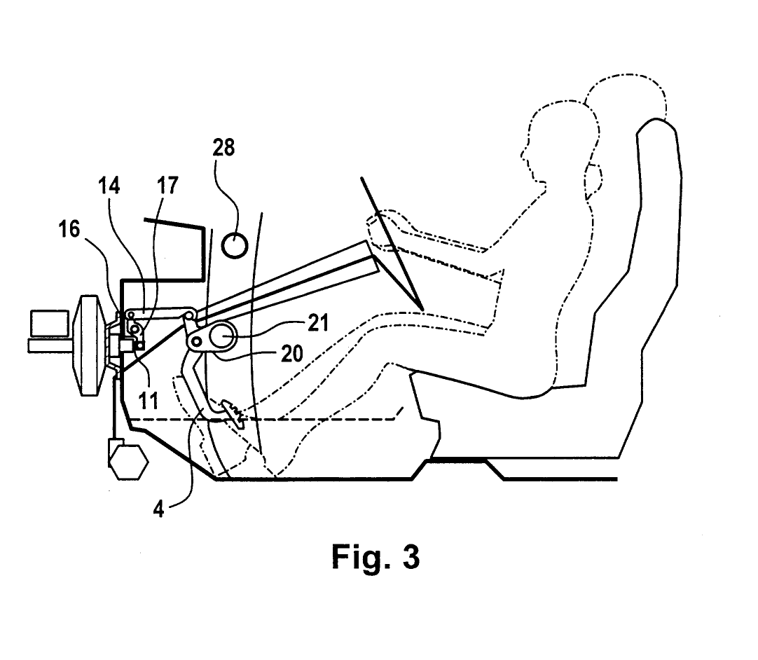

FIG. 3 shows a second embodiment of the present invention wherein the pedal lever 4 is not mounted in a pedal stand 2 but optionally directly in a swing support 20 that is attached to a transverse bar 21. This makes it impossible for forces produced in an accident to be transmitted from the actuating rod 11 directly to the pedal lever 4. Thus, the driver is only jeopardized by pressure forces in the extended tie rod 14, but said pressure forces cannot be exerted by the turning lever 17, as has been explained already, because the end of the turning lever 17 facing the tie rod 14 impacts against the splashboard.

It would, however, be possible in an accident that the forces that act on the zone 16 of the splashboard 5 exert sufficient pressure forces on the tie rod 14. In order to provide for the necessary safety also in this event, the design of the tie rod 14 is such that it permits transmitting essentially tensile forces only, as can be seen in FIG. 5. Hence, a simple solution according to FIG. 5 involves having the first swivel joint 3 engage a hook 24 at the end of the tie rod. The configuration of hook 24 is such that it disengages when pressure forces of a sufficient magnitude exist so that a transmission of force is no longer possible.

The transverse bar 21 similar to the second transverse bar 24 is mounted between the A-columns 25 of the vehicle, thus extending in parallel to it. However, it is also feasible that the swing support 20 is attached to the transverse bar 24, with an appropriate position of the second transverse bar 24, or that the transverse bar 21 is supported in the area of the center console.

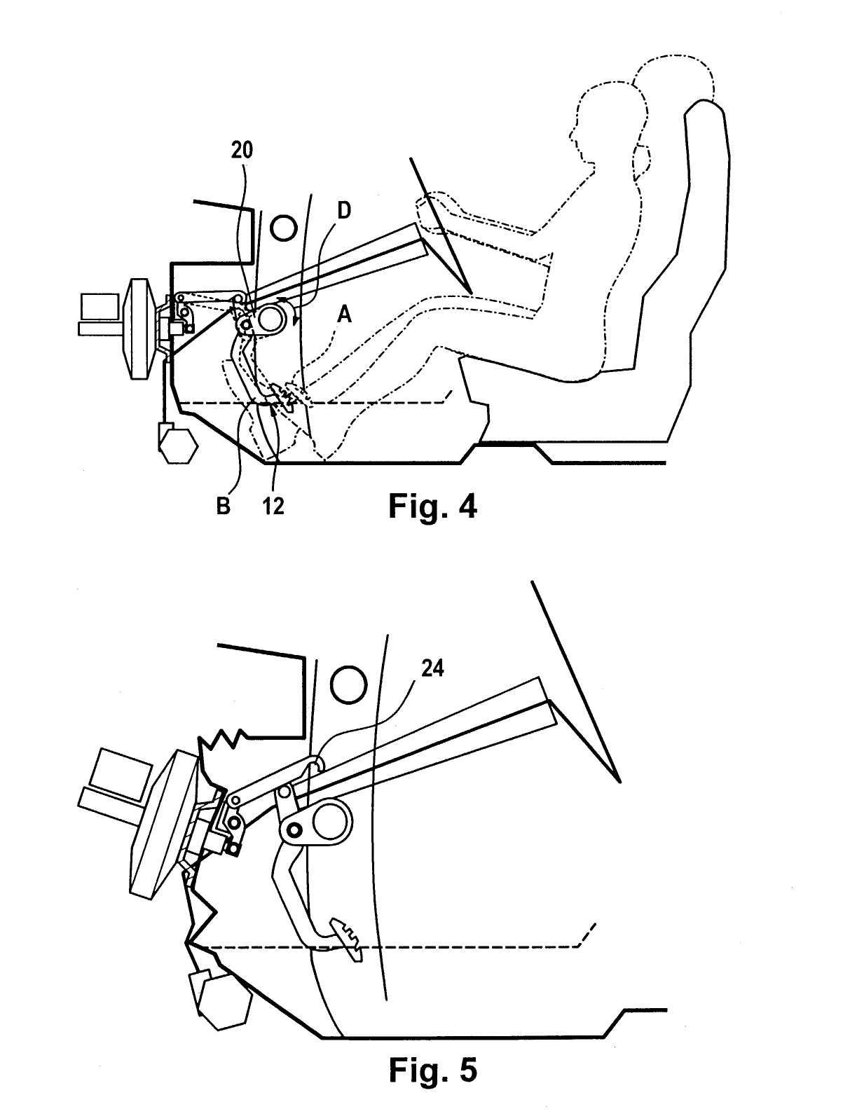

As can be seen in FIG. 4, the swing support 20 may also be arranged in a rotatable manner, thereby permitting an adjustment of the initial position of the pedal support 12. When the swing support 20 in FIG. 4 is rotated in any one of the two directions of the double arrow D, the pedal support 12 in FIG. 4 is either swung to the right towards the driver or to the left towards the splashboard. This way the initial position of the pedal 12 may be adjusted and adapted to the driver's height. The position A for a small driver and the position B for a tall driver can be seen in FIG. 4. The swing support 20 can be turned by means of an electric motor, which is not illustrated in the drawings. Provision must be made that the swing support 20 is immovably fixed in its new position. It is preferred to use a self-locking drive of the electric motor for this purpose.

FIG. 5 shows the possible results in case the booster digs crossly into the splashboard in a crash. In FIG. 5 the top area of the booster is dented, causing displacement of the tie rod 14 basically to the right. The pedal lever 4 and, thus, the pedal support 12 is clockwise swung to the left in this case so that the pedal support 12 is moved out of the danger zone as a result of the accident. This means that the forces that developed from the accident contribute to preventing the driver from being injured by the pedal lever 4. Further, FIG. 5 shows that when the forces caused by the accident exceed a limit, the tie rod will disengage from its connection to the pedal lever, which also contributes to avoiding accident hazards. Hence, the pressure force admitted for being transmitted by the push rod 14 in the event of a crash is utilized for swinging the pedals away from the driver.

1. Crash-safe pedal assembly in a vehicle for the actuation of an actuating rod (11), in particular for a control unit (7) comprising a master cylinder (8) and/or a brake booster (9) in a brake system, characterized in that a lever system is so arranged between the pedal lever (4) of the pedal assembly and the actuating rod (11) that the force exerted by the pedal lever (4) on the actuating rod (11) is transmitted by way of a tie rod (14).

2. Pedal assembly as claimed in claim 1, characterized in that during the transmission of forces the tie rod (14) is moved substantially perpendicular to the splashboard (5) of the vehicle, and that in the inactive position of the pedal assembly, the end of the tie rod (14) close to the splashboard (5) is in direct proximity to the splashboard or any part that is in a force-transmitting connection with the splashboard.

3. Pedal assembly as claimed in claim 2, characterized in that at least one of the ends of the tie rod (14), preferably the end of the tie rod (14) that engages the pedal lever (4), includes a connecting member (24) for force transmission in such a way that only tensile forces are allowed to be transmitted by way of the tie rod (14), while the connection is disengaged when a force exceeding a threshold value is transmitted.

4. Pedal assembly as claimed in claim 3, characterized in that the connecting member (24) generally has the configuration of a hook.

5. Pedal assembly as claimed in any one of the preceding claims, characterized in that the pedal lever (4) is designed as a turning. lever,, with the pivot bearing being supported by a transverse bar (21) that is preferably mounted between the A-columns (25) of the vehicle.

6. Pedal assembly as claimed in claim 5, characterized in that the transverse bar (21) is arranged generally in parallel to the instrument panel (28) in the vehicle.

7. Pedal assembly as claimed in any one of claims 5 or 6, characterized in that the turning lever (4) is mounted in a swing support (20) which is rotatable about the transverse bar (21), and that the normal position of the pedal lever (4) is adjustable by turning the swing support (20).

8. Pedal assembly as claimed in claim 7, characterized in that the swing support (20) is turned by means of an electric motor, and that the swing support (20) includes a safety mechanism which locks the swing support in its new angular position.

9. Pedal assembly as claimed in any one of claims 1 to 8, characterized in that the control units are so mounted on the splashboard (5) that part of the forces caused by a crash are directed at the splashboard (5) against the end of the tie rod (19) facing the splashboard.

10. Pedal assembly as claimed in claim 9, characterized in that the forces introduced into the tie rod (14) in the case of a crash are pressure forces which act upon the pedal lever (4) in such a manner that said lever is swung away from the driver.

11. Pedal assembly as claimed in claim 9 or 10, characterized in that the connection between the tie rod (14) and the pedal lever (4) at the end of the pedal lever facing the tie rod (14) is disengaged when the pressure forces exceed a predetermined threshold value.

12. Pedal assembly as claimed in any one of claims 7 to 9, characterized in that there is provision of a sensor which, in the case of a crash, activates the electric motor so that said will swing the pedals (12) towards the splashboard.
